(19) United States
(12) Patent Application Publication
(10) Pub. No.: US 2014/0373623 A1
(43) Pub. Date: Dec. 25, 2014

(54) Filling level sensor in a fuel tank of a motor vehicle, production method for such a filling level sensor, and method for operating such a filling level sensor

(71) Applicant: CONTINENTIAL AUTOMOTIVE GMBH, Hannover (DE)

(72) Inventor: Thomas Klein, Dortmund (DE)

(21) Appl. No.: 14/364,985

(22) PCT Filed: Dec. 13, 2012
(86) PCT No.: PCT/EP2012/075466

§ 371 Date: Jun. 12, 2014

(30) Foreign Application Priority Data
Dec. 16, 2011 (DE) 10 2011 088 816.0

(51) Int. Cl. G01F 23/36

(52) U.S. Cl. CPC G01F 23/36
USPC 73/313

(57) ABSTRACT

A filling level sensor in a fuel tank of a motor vehicle includes a substrate having a resistance network arranged thereon, one or more electrical contacts, which are in contact with the resistance network in order to produce an electrical signal depending on the pivoting of a lever arm, and a float, which is fastened to the lever arm in such a way that the lever arm can be moved by the float in accordance with the filling level. The filling level sensor is connected to electronics, and the electronics are designed in such a way that the electronics provide a respective corresponding electrical target signal for each of the electrical signals generated by the filling level sensor.

### CROSS-REFERENCE TO RELATED APPLICATIONS

This is a U.S. national stage of application No. PCT/EP2012/075466, filed on 13 Dec. 2012, which claims priority to the German Application No. 10 2011 088 816.0, filed Dec. 2011, the content of both incorporated herein by reference.

### BACKGROUND OF THE INVENTION

1. Field of the Invention

The invention relates to a filling level sensor in a fuel container of a motor vehicle, comprising a resistance network, one or more electrical contacts, which are in contact with the resistance network, as a function of the pivoting of a lever arm, in order to produce an electrical signal, and a float which is fastened to the lever arm in such a way that the lever arm can be moved by the float as a function of the filling level. The invention also relates to a manufacturing method for such a filling level sensor and a method for operating such a filling level sensor.

2. Related Art

Level sensors are known. The electrical contacts can be embodied as sliding contacts fastened to a bow. The bow is connected to the lever arm, with the result that the electrical contacts can be moved by the lever arm. The bow is mounted in a carrier to ensure the pivoting of the lever arm. At the same time the resistance network is arranged in the carrier. It is also known to embody the electrical contacts as a plurality of flexible springs of a contact spring structure placed in contact with the resistance network by a magnet, wherein the flexible springs that are connected to the resistance network depend on the position of the magnet, and the magnet is connected to the lever arm and is moved via the contact spring structure when the lever arm pivots.

It is also known that fuel containers in motor vehicles have a shape that deviates from basic geometric shapes, as a result of which the filling level is not proportional to the filling level height. So that the electrical signal produced during the pivoting of the lever arm corresponds to the filling level, the ratio of the filling level height to the filling level is mapped as a characteristic curve in the resistance network. However, the electrical signal ultimately produced depends on the component tolerances ranging from the float to the contact at the resistance network and the mounting of the filling level sensor. This results in the electrical signal actually produced deviating from the electrical signal that is theoretically necessary according to the characteristic curve. Therefore, each filling level sensor has to be adjusted manually so that the electrical signal produced at a certain deflection angle of the lever arm also corresponds to the electrical signal that is theoretically necessary for this deflection angle, wherein the testing is limited, owing to the complexity, to a few significant points such as “empty”, “reserve”, “¼”, “½” and “full”. The manual adjustment prevents automatic installation of the filling level sensor and also requires additional expenditure of time.

### SUMMARY OF THE INVENTION

It is an object of the invention to provide a filling level sensor that requires little expenditure for adjustment. In particular, the expenditure in terms of personnel is to be reduced. A second object is to provide a manufacturing method for such a filling level sensor. A third object is to provide a method for operating such a filling level sensor.

The first object can be achieved in that the filling level sensor is connected to electronics and in that the electronics are embodied such that the electronics provide, in each case, a corresponding electrical setpoint signal for the electrical signals produced by the filling level sensor.

As a result of the assignment and provision of the electrical setpoint signal corresponding to the electrical signal produced as a function of the pivoting angle of the lever arm, a type of corresponding signal for the further display is provided. As a result of the electrical signal produced being adjusted electronically in this way by the corresponding setpoint signal, mechanical adjustment of the lever arm in order to obtain an electrical signal that corresponds as precisely as possible to the filling level characteristic curve is no longer necessary. The operations necessary here for the electronic adjustment can proceed in an automated fashion. In addition, the corresponding electrical signal is assigned and provided more quickly than the manual adjustment of the lever arm. The electronic adjustment also permits adjustment over the entire pivoting angle of the lever arm without the time required being significantly longer than in the case of electronic adjustment of individual points. In the case of repair or maintenance the filling level sensor is also functionally capable again with little expenditure.

A further advantage is that the filling level sensors with the same resistance network are used for fuel containers with similar characteristic curves. The precise adaptation of the filling level sensor to the respective characteristic curve is carried out by the assignment and provision of the corresponding electrical setpoint signals. As a result, it is no longer necessary to develop and produce a separate resistance network for every design of fuel container. In addition, already existing resistance networks can also be used for new fuel containers. This results in lower fabrication costs and storage and logistics costs owing to the smaller variety of types.

In one advantageous embodiment, a linear resistance network can be used, which is distinguished by the fact that it is of simpler design and is easier to manufacture. Linear means here that with such a resistance network a characteristic curve that is linear as a function of the pivoting angle of the lever arm is produced, while previous resistance networks have produced nonlinear characteristic curves owing to the complicated designs of the fuel containers with respect to the pivoting angle. The electrical signals produced by such a linear resistance network are therefore subject to relatively large errors owing to the shape of the respective fuel container, and nevertheless by the assignment of the specific characteristic curve to the corresponding setpoint signals it is possible to generate an electrical signal which precisely reproduces the actual filling level.

In one refinement, the electronics are connected to a display unit in which the corresponding electrical setpoint signal can be displayed. This display unit can be, for example, a combination instrument of the motor vehicle.

The electrical signals that can be produced and the corresponding electrical setpoint signals are advantageously stored in a programmable module, which is a component of the electronics.

The electronics are configured in a relatively simple and therefore cost-effective fashion if they are electronics which are provided exclusively for operating the filling level sensor. In a particularly simple embodiment, these electronics are arranged on the carrier or on the substrate of the filling level sensor.

A separate arrangement of the electronics is avoided if the electronics are integrated into further electronics. In this context it is advantageous if for this purpose electronics in the vicinity of the filling level sensor are used, such as is the case, for example, with electronics for controlling the fuel pump. Such electronics are arranged, for example, in a flange for closing of an opening in a fuel container.

In another embodiment, the electronics are integrated into an engine controller of the motor vehicle. Since engine controllers contain a plurality of individual controllers and are correspondingly equipped in terms of hardware and the electronics constitute a relatively small expenditure for the filling level sensor compared thereto, the electronics can be integrated at low cost into the engine controller without hardware extensions to the engine controller having to be implemented for this purpose.

The elimination of the mechanical adjustment of the lever arm additionally removes the need to use, as the material of the lever arm, a material that can be easily and quickly adjusted manually, such as, a metal wire. The filling level sensor according to the invention therefore permits other material to be used for the lever arm. In this context, it has proven advantageous to manufacture the lever arm from a fuel-resistant plastic. The use of plastic permits a more lightweight material than metal to be used, wherein the necessary dimensional stability is provided by the cross-sectional design of the lever arm and not by the quantity of material used. The resulting saving in weight has a positive effect on the float since, owing to the weight of the lever arm, the float has to have correspondingly large dimensions or a very small density in order to obtain the necessary buoyancy. The use of plastic as a lever arm now permits the use of floats with relatively small dimensions or of floats made of materials with a relatively large specific density, which floats are generally more cost-effective.

The second object is achieved in that electrical signals produced as a function of the pivoting angle of the lever arm are assigned to corresponding electric setpoint signals of the same respective pivoting angle, and in that this assignment of the electrical signals is stored in electronics.

In this method, the lever arm is moved from one end position into the other end position. The electrical signals produced in the process are assigned to setpoint signals that predefined as a function of the pivoting angle of the lever arm, with the result that the electrical signal respectively produced by the filling level sensor and the corresponding setpoint signal are available for the detected pivoting angle of the lever arm. This assignment of the two signals to a specific pivoting angle is stored in the electronics for the filling level sensor. As a result, the filling level sensor is adjusted electronically, with the result that mechanical adjustment of the lever arm in order to adapt the produced electrical signals to the pivoting angle is no longer necessary. A further advantage of this method is that the assignment is carried out by pivoting the lever arm just once. Multiple readjustment, as is usually the case when adjusting manually, is eliminated.

The assignment can be checked at low cost in that before the storage of the assignment the lever arm is moved a second time from one end position into the other end position, and in that the signals of the first pivoting are compared with the signals of the second pivoting, and the assignment to the corresponding setpoint signals is not performed until they correspond.

The expenditure on the electronics is reduced considerably if only a few significant points of the filling level are stored according to this method. Such points are the “empty”, “reserve”, “¼”, “½” and “full” filling levels. Only the electrical signals produced here are assigned to the corresponding electrical setpoint signals of the same respective pivoting angle. The electrical signals that can be produced, and which lie between these filling levels, are interpolated for the assignment to the electrical setpoint signals.

Precise reproduction of the characteristic curve is advantageous for a high level of accuracy of the filling level display over the entire range, wherein signals in steps of 1°, preferably 3° and in particular 5°, of the pivoting angle of the lever arm are used for the assignment of the electrical signals that can be produced. The corresponding step width can be selected in accordance with the design and volume of the container and the pivoting angle.

The storage of the assignment is particularly simple if the assignment of the electrical signals takes place in a programmable module of the electronics.

The third object is achieved in that the electrical signals produced by the filling level sensor are fed to electronics, and in that a corresponding electrical setpoint signal is provided in the electronics as a function of the produced electrical signal of the filling level sensor.

By way of this method, an electrical signal produced at a specific pivoting angle of the lever arm is fed to the electronics. By the assignment of the produced electrical signal, stored in the electronics during manufacture, to a corresponding electrical signal for one specific pivoting angle in each case, the electronics are capable of providing the corresponding electrical setpoint signal that corresponds to this pivoting angle, with the result that the signal can be passed on, for example, to a display unit for the filling level. In this case, a defined setpoint signal is always provided at each pivoting angle in each filling level sensor by the electronics. The variation range of the signal at a specific pivoting angle is thereby reduced to zero. This has an advantageous effect on downstream devices that process these electrical signals since they also no longer need to take account of the variation range of the electrical signals.

### BRIEF DESCRIPTION OF THE DRAWINGS

The invention will be explained in more detail with reference to an exemplary embodiment. In the drawings:

FIG. 1 shows a fuel container,

FIG. 2 shows a filling level sensor in the final checking, and

FIG. 3 shows the electrical signals as a function of the pivoting angle.

### DETAILED DESCRIPTION OF THE PRESENTLY PREFERRED EMBODIMENTS

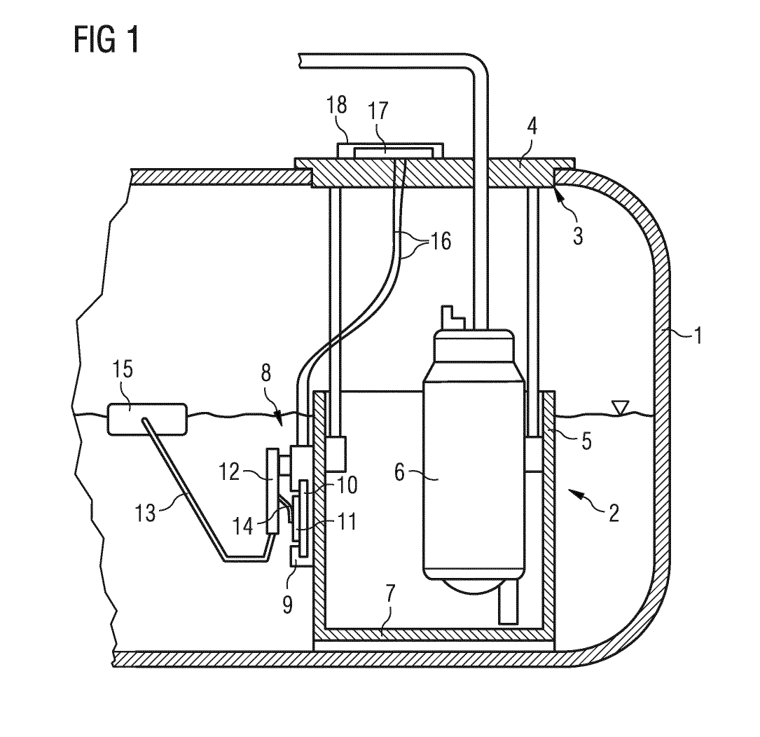

The fuel container 1 illustrated in FIG. 1 contains a feed unit 2. The feed unit 2 is inserted through an opening 3 in the fuel container 1, wherein a flange 4 closes off the opening 3 in the fuel container 1. The feed unit 2 comprises a surge pot 5, which as well as fuel accommodates, inter alia, a fuel pump 6 arranged therein and which feeds the fuel to an internal combustion engine (not illustrated) of the motor vehicle. The surge pot is connected to the flange 4 via two support elements 7 such that the feed unit 2 is seated with the surge pot 5 on the base of the fuel container 1. A filling level sensor 8 is fastened to the surge pot 5. The filling level sensor 8 has for this purpose a carrier 9 for fastening to the surge pot 5. A substrate 10 with a resistance network 11 arranged thereon is fastened to the carrier in an encapsulated or unencapsulated form. A lever arm 13, which is held in a bow 12, is mounted on the carrier 9 such that it can pivot over the substrate 10 with the resistance network 11. One or more electrical contacts 14 are connected to the resistance network 11 as a function of the pivoting of the lever arm 13, with the result that an electrical signal is produced. The lever arm 13 is pivoted as a function of the filling level in the fuel container 1 by virtue of the fact that the free end of the lever arm 13 is connected to a float 15. The resistance network 11 is connected via two electrical lines 16 to electronics 17, which are arranged in the flange 4, wherein the electronics 17 are arranged on the side of the flange 4 facing the outside of the fuel container 1. In order to provide protection against environmental influences, the electronics 17 are covered with a housing 18.

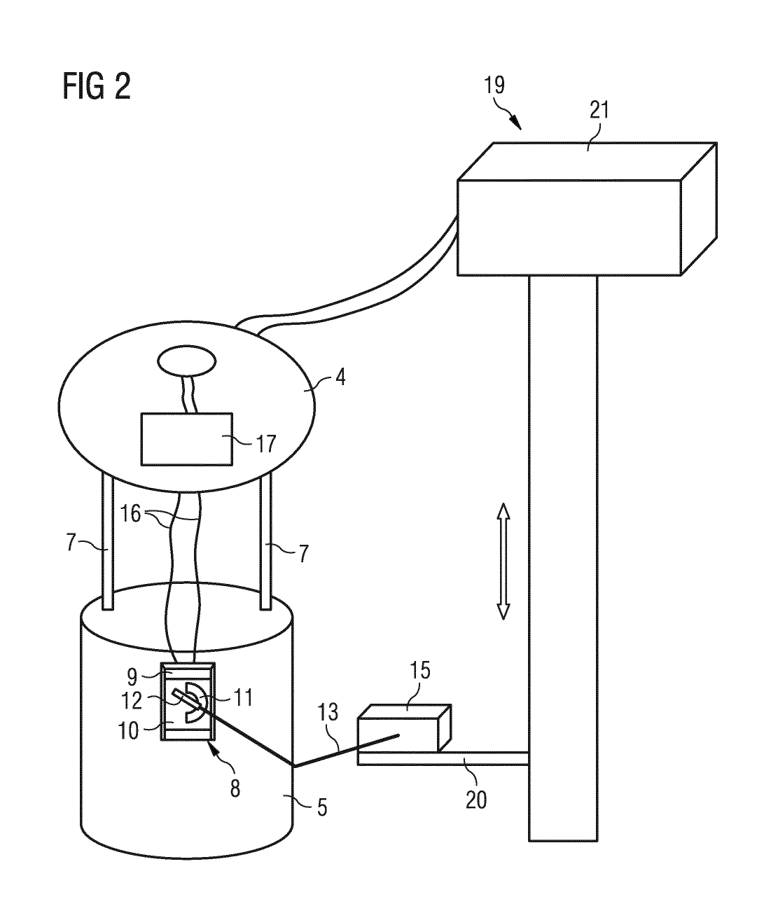

FIG. 2 shows the fuel feed unit 2 in a checking station. For this purpose, the electronics 17 of the filling level sensor 8 are connected to the checking station 19. The float 15 is moved from one end position into the other end position via a corresponding device 20. During this movement, the filling level sensor 8 produces a plurality of electrical signals which are stored by the testing electronics 21 via the electrical lines 16 and the electronics 17. At the same time, the corresponding pivoting angle is determined from the movement of the device 20, with the result that a produced electrical signal of the filling level sensor 8 is assigned to each pivoting angle. The tank characteristic curve is also stored in the testing electronics 21, wherein the tank characteristic curve signifies, as a function of the shape of the fuel container 1 and of the planned pivoting angle of the filling level sensor 8, the setpoint signals that have been assigned to the respective pivoting angles. The corresponding setpoint signals can then be assigned to the measured electrical signals by these pivoting angles.

These steps have been fed from the lower end position into the upper end position during a movement of the float 15. When the device 20 is moved back into the home position, the float 15 is moved forcibly from the upper end position into the lower end position. This movement is used to check the first movement by virtue of the fact that the steps mentioned at the beginning are repeated. The electrical signals produced are then compared as a function of the pivoting angle from both movements. If the two signal series correspond, the assignment of the corresponding setpoint signals to the produced electrical signals is stored in the electronics 17 in the flange 4.

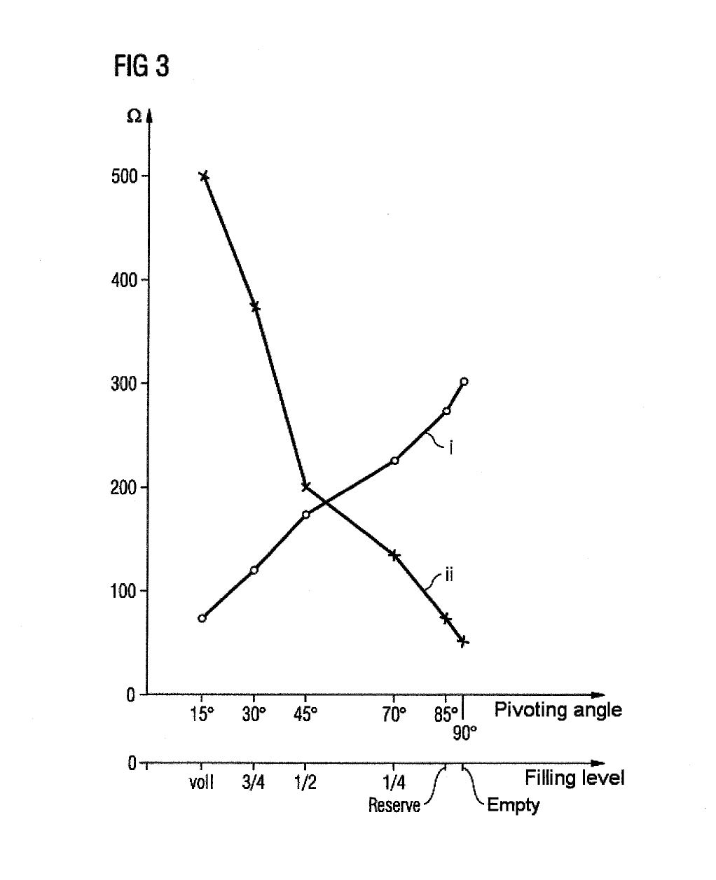

FIG. 3 shows a diagram with two signal series. The signal series i shows the electrical signals produced by the filling level sensor, while the signal series ii shows the respectively corresponding setpoint signal provided by the electronics for passing on. For example, in the case of a pivoting angle of 70° an electrical signal of 220Ω is produced. A setpoint signal of 130Ω is assigned thereto, with the result that in the case of an input signal of 220Ω the electronics provide an output signal of 130Ω.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-16. (canceled)

17. A filling level sensor (8) in a fuel container (1) of a motor vehicle, comprising:
a substrate having a resistance network arranged thereon;
a pivotable lever arm (13);
one or more electrical contacts configured to contact the resistance network as a function of a pivoting of the lever arm (13) to produce electrical signals; and
a float fastened to the lever arm such that the lever arm is movable by the float as a function of the filling level in the fuel container,
wherein the filling level sensor (8) is connected to electronics (17) configured to provide a corresponding electrical setpoint signal for the electrical signals.

18. The filling level sensor as claimed in claim 17, wherein the electronics (17) are connected to a display unit in which the corresponding electrical setpoint signal can be displayed.

19. The filling level sensor as claimed in claim 17, wherein the electronics (17) have a programmable module (22) in which the electrical setpoint signals corresponding to the electrical signals are stored.

20. The filling level sensor as claimed in claim 17, wherein the electronics (17) are provided exclusively for operating the filling level sensor (8).

21. The filling level sensor as claimed in claim 19, further comprising a carrier (9), wherein the electronics (17) are arranged on the carrier (9) or on the substrate (10).

22. The filling level sensor as claimed in claim 17, wherein the fuel container (1) has an opening (3), and the filling level sensor further comprises a flange (4) configured to close the opening (3), the electronics (17) being integrated into further electronics arranged in the flange (4).

23. The filling level sensor as claimed in claim 17, wherein the electronics (17) are integrated into an engine controller of the motor vehicle.

24. The filling level sensor as claimed in claim 17, wherein the resistance network (11) is a linear resistance network.

25. The filling level sensor as claimed in claim 17, wherein the lever arm (13) is composed of a fuel-resistant plastic.

26. A method for manufacturing a filling level sensor, comprising:
moving a pivotably movable lever arm from one end position into another other end position;
assigning electrical signals produced as a function of a pivoting angle of the lever arm to corresponding electrical setpoint signals of the same respective pivoting angle; and
storing the assigned setpoint signals in electronics.

27. The method as claimed in claim 26, further comprising:
before storing the results of the assigning, moving the lever arm a second time from one end position into the other end position;
comparing the electrical signals produced by the second moving of the lever arm as a function of the pivoting angle of the lever arm with the signals associated with the first pivoting of the lever arm; and
delaying storage of the results of the assigning until the compared signals correspond.

28. The method as claimed in claim 26, further comprising:
moving the lever arm into pivoting angles corresponding to “empty”, “reserve”, “¼”, “½” and “full” filling levels;
assigning only the electrical signals produced at the pivoting angles to the corresponding electrical setpoint signals of the same respective pivoting angle; and
interpolating the electrical signals which can be produced and which lie between the pivoting angles corresponding to the filling levels for the assignment to the electrical setpoint signals.

29. The method as claimed in claim 26, wherein signals in steps of 1° of the pivoting angle of the lever arm are used for the assignment of the electrical signals which can be produced.

30. The method as claimed in claim 26, wherein the assignment of the electrical signals takes place in a programmable module of the electronics.

31. A method for operating a filling level sensor, comprising:
placing electrical contacts in contact with a resistance network as a function of pivoting of a lever arm, such that an electrical signal which corresponds to the filling level is produced in the resistance network;
feeding the produced electrical signal to electronics; and
generating in the electronics an electrical setpoint signal corresponding to the produced electrical signal.

32. The method as claimed in claim 29, wherein the corresponding electrical setpoint signal is passed on to a display unit for displaying the filling level.

33. The method as claimed in claim 26, wherein signals in steps of 3° of the pivoting angle of the lever arm are used for the assignment of the electrical signals which can be produced.

34. The method as claimed in claim 26, wherein signals in steps of 5° of the pivoting angle of the lever arm are used for the assignment of the electrical signals which can be produced.
